(19) United States
(12) Patent Application Publication
(10) Pub. No.: US 2011/0055412 A1
(43) Pub. Date: Mar. 3, 2011

(54) System for Conversion of SIP Messages

(75) Inventors: George Philip Kongalath, Saint-Laurent (CA); Ravi Gattu, Haninge (SE)

(73) Assignee: TELEFONAKTIEBOLAGET L M ERICSSON (PUBL), Stockholm (SE)

(21) Appl. No.: 12/990,501

(22) PCT Filed: Jun. 4, 2009
(86) PCT No.: PCT/SE2009/050663

§ 371 Date: Oct. 30, 2010

Related U.S. Application Data
(60) Provisional application No. 61/059,077, filed on Jun. 5, 2008.

(51) Int. Cl. G06F 15/16

(52) U.S. Cl. 709/228

(57) ABSTRACT

SIP is a popular protocol used in communications over IP, which however is incompatible with many other protocols used for the set-up of calls in other networks. SIP-based transactions are converted through the use of a grammar by a proxy user agent (110) into a format which is usable by non-SIP capable end user devices, e.g., a mobile phone, such that the end user devices (116) has access on services and applications which use SIP-based transactions.

### TECHNICAL FIELD

The present invention relates generally to communications and, in particular, to systems and methods which enable devices that are not Session Initiation Protocol (SIP)-capable to access services which use SIP-based transactions.

### BACKGROUND

In recent years, interest in using mobile and landline/wireline computing devices in day-to-day communications has increased. Desktop computers, workstations, and other wireline computers currently allow users to communicate via, for example, e-mail, video conferencing, and instant messaging (IM). Mobile devices, such as mobile telephones, handheld computers, personal digital assistants (PDAs), etc., also allow the users to communicate via e-mail, video conferencing, IM, and the like. Mobile telephones have conventionally served as voice communication devices but, through technological advancements, they have recently proven to be effective devices for communicating data, graphics, etc. Wireless and landline technologies continue to merge into more unified communication systems, as user demand for seamless communications across different platforms increases.

Many communication applications allow for real-time or near real-time communications that fall outside of the traditional voice communications associated with wireline and wireless telephone communications. Chat sessions, instant messaging, Short Message Service (SMS), and video conferencing are a few such communication vehicles. Many of these types of communications are expected to become increasingly popular, particularly in view of the proliferation of wireless devices and continual technological breakthroughs in this area.

However, as these communication options continue to proliferate, new protocols and programs are often required to access these service options. For example, when using Session Initiation Protocol (SIP) in an Internet Multimedia Subsystem (IMS) environment, a SIP user agent is typically provided as part of the software associated with SIP-capable devices. A user agent is a software entity which includes a SIP stack with an application layer on top. The application layer decodes the SIP message sequences and generates appropriate transactions towards the SIP-capable device's user, e.g., input/output requests, data streaming, action on data sets, etc. SIP-capable devices can include personal computers (PCs), set-top boxes, mobile phones, and the like.

Of course, SIP user agents can only be installed on devices that are capable of hosting that sort of software entity. In today's telephony market place, for example, it is estimated that close to 90% of the existing mobile units are unable to load a client with a user agent that is capable of terminating SIP sessions for various reasons. A large contributor to this issue is the large number of different mobile phone models that have to be considered. Each different model requires that the user agent client be designed and tested for its architecture, which is an expensive process. Another contributor to this problem is that some mobile phone models also do not have the resources, e.g., memory, central processing unit (CPU) power, and graphic ability, to enable a SIP user agent/client to running on those platforms.

Accordingly, systems and methods which enable the termination of a SIP application client into any device on which service is to be rendered, i.e., including those which do not run a SIP user agent, are desirable.

### SUMMARY

Exemplary embodiments relate to systems and methods for using a proxy user agent for terminating Session Initiation Protocol (SIP)-based transactions on behalf of a non-SIP capable end user device. A number of signaling variations and grammars are contemplated to resolve this issue. Advantages according to exemplary embodiments described herein include, for example, the capability to convert from SIP protocols to another grammar useable by a target, end user device in a manner which can flexibly accommodate the large number of legacy mobile phone models, and other devices. However, it will be appreciated by those skilled in the art that such advantages are not to be construed as limitations of the present invention except to the extent that they are explicitly recited in one or more of the appended claims.

According to an exemplary embodiment, a method for converting Session Initiation Protocol (SIP)-based messages associated with an application into signals based on a grammar usable by a non-SIP capable end user device is described. SIP-based messages are received at aproxy user agent, which messages are to be sent to the non-SIP capable end user device. These SIP messages are converted, by the proxy user agent, into signals based on the grammar which is usable by the non-SIP capable end user device. These signals are transmitted toward the non-SIP capable end user device. In response, signals based on the grammar are received, by the proxy user agent from the non-SIP capable end user device, which signals are then converted into SIP signals. The resultant signals are then transmitted toward an application server.

According to another exemplary embodiment, a method for providing a service to a non-Session Initiation Protocol (SIP) capable end user device is described. One of a plurality of grammars to use for converting SIP messages associated with the service to be transmitted to the non-SIP capable end user device is determined by an application server. Then, a SIP message is transmitted by the application server toward a proxy user agent, which message includes an identifier associated with the non-SIP capable end user device, e.g., a Uniform Resource Identifier. The message can also include an identifier associated with the determined grammar, or the grammar itself. This information can be used by the proxy user agent to process subsequently received SIP messages from the application server, and to send SIP messages to the application server, associated with providing the service to the non-SIP capable end user device.

According to another exemplary embodiment, a proxy user agent for converting Session Initiation Protocol (SIP)-based messages associated with an application based on a grammar which is usable by a non-SIP capable end user device is described. The proxy user agent includes a communications interface for receiving and transmitting signals, wherein the received signals include the SIP-based messages which are to be sent to the non-SIP capable end user device. The communications interface also transmits signals toward the non-SIP capable end user device, using the grammar, and SIP signals towards an application server which supports the application. The proxy user agent also includes a memory for storing the grammar and a processor for converting SIP-based messages associated with the application into signals based on the grammar which are usable by the non-SIP capable end user device and for converting signals based on the grammar and associated with the application from the non-SIP capable end user device into SIP signals,

According to another exemplary embodiment, an application server for providing a service to a non-Session Initiation Protocol (SIP) capable end user device is described. The application server includes a memory for storing a plurality of grammars and a processor for determining which one of the plurality of grammars to use for converting SIP messages associated with service to be transmitted to the non-SIP capable end user device. Additionally, the application server includes a communications interface for transmitting, toward a proxy user agent, a SIP message including a first identifier associated with the non-SIP capable end user device and at least one of: a second identifier associated with the one of the plurality of grammars and the one of the plurality of grammars itself, wherein the communications interface further sends and receives, subsequent SIP messages associated with providing the service to non-SIP capable end user device to and from the proxy user agent, respectively.

### BRIEF DESCRIPTION OF THE DRAWINGS

The accompanying drawings illustrate exemplary embodiments, wherein:

FIG. 1 depicts a communication system according to exemplary embodiments;

FIGS. 2(a) and 2(b) illustrate a signaling diagram used for performing an authorization between a bank and an end user device according to exemplary embodiments;

FIG. 3 shows a signaling diagram for changing a grammar by an end user device according to exemplary embodiments;

FIGS. 4(a) and 4(b) illustrate a signaling diagram used for performing authorization between a bank and an end user device when the end user device's grammar preference is known according to exemplary embodiments;

FIG. 5 depicts a communication node according to exemplary embodiments;

FIG. 6 shows a method flowchart according to exemplary embodiments; and

FIG. 7 is a flowchart depicting a method according to another exemplary embodiment.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

Systems and methods according to the following exemplary embodiments can be used to increase the number of end user devices which can access services using Session Initiation Protocol (SIP)-based transactions, which transactions typically require the termination of an application client on the end user device. According to exemplary embodiments, one solution is to define a session proxy server that is able to terminate an application client for any device on which service is to be rendered. The exemplary termination methodologies described below are therefore not based on core methods, e.g., hard-coded solutions. Instead they are based, at least in part, on one or more grammars which are defined by the application server (AS) and which describe methods for a proxy user agent to terminate a message into an end user device which is currently non-SIP capable. The grammars explicitly define, for example, the inputs/outputs, graphic alternatives and error handling options associated with terminating an incoming SIP message, as well as other conversions and communications needed, into a particular end user device based upon its particular capabilities. This makes exemplary embodiments scalable and adjustable to evolving technologies without the need to perform physical core updates to handle, e.g., new mobile telephone models.

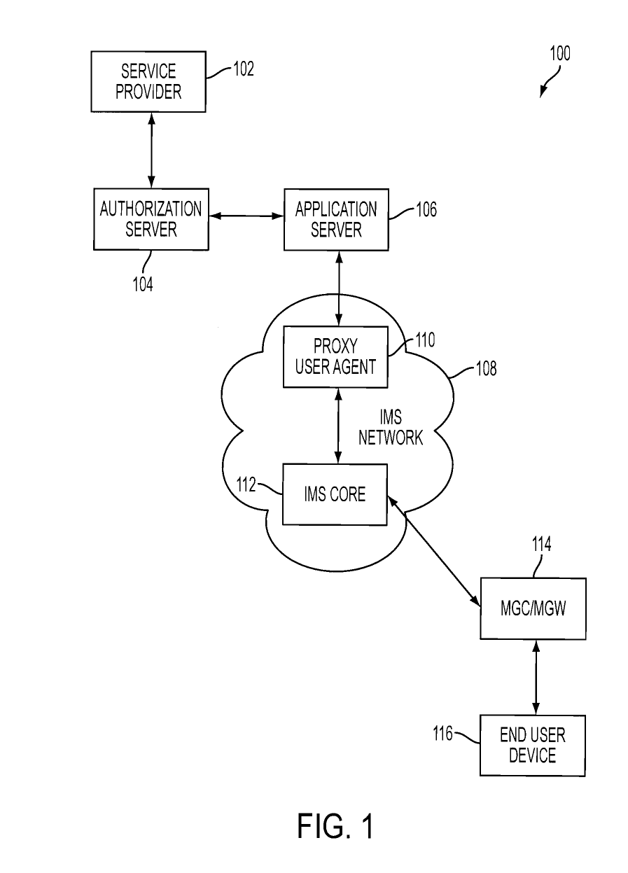

According to exemplary embodiments, when an application tries to render service to a device that is incapable of having (or contacting) a local client with a SIP user agent installed, the service is redirected to a proxy user agent/client which has a standardized syntax to be able to send analog or digital commands to that end user device for processing in accordance with the relevant service. In addition to SIP-incapable user equipments, this solution can also be used to handle service provision to end user devices which are nominally SIP-capable but which are unable to support the desired SIP service for various reasons, such as, inability to register with the system, crashes and bugs. As used herein, the term “non-SIP capable” refers generically to both end user devices which cannot or do not have a SIP user agent client running thereon and to end user devices which have a SIP user agent client running thereon, but which is unable for some reason to terminate a particular SIP application thereon. Prior to discussing the exemplary embodiments below, a purely illustrative communication system in which services which have typically required the termination of an application client on the end user device may be used will now be described with respect to FIG. 1 to provide some context for this discussion.

According to exemplary embodiments, a communication system in which a grammar can be used to deliver a service using SIP-based transactions or messages to an end user device which is non SIP-capable is shown in FIG. 1. Communication system 100 includes various, exemplary communication nodes used to facilitate a transaction completion and/or to render a service. For example, communication system 100 includes a service provider 102, e.g., a bank, an authorization server 104 and an application server (AS) 106. The authorization server 104 performs authorizing functions associated with the service provider 102 and the application server 106 contains applications associated with the service provider 102. Additionally, the application server 106 can include a variety of grammars and codecs for allowing different types of non-SIP capable end user devices 116 to have access to the available applications which application server 106 contains. As used herein the term “grammar” generally includes, but is not limited to, a method, rule set or coding which allows SIP signaling to be translated or converted into a format such that a SIP termination can be performed by a proxy with the information being sent to the end user device 116, which is currently not capable of using SIP signaling, for use of the application or service. For example, the grammar could be a method that converts SIP message information into an American Standard Code for Information Interchange (ASCII) code useable by the end user device 116, which allows the user to, for example, experience a level of interactive content associated with a SIP service by making such content displayable on his or her end user device. However, other grammars that perform a similar function which are understandable by other, non-SIP capable end user devices 116 may also be available, e.g., to support different mobile phone models, which other grammars can involve, e.g., Interactive Voice Response (IVR), Hyper Text Transfer Protocol (HTTP), and the like.

According to this exemplary embodiment, the application server 106 is in communication with a proxy user agent 110 within an Internet Protocol Multimedia Subsystem (IMS) network 108. Proxy user agent 110 can be a standalone node within the IMS core network (or elsewhere in the IMS network) or co-located with another node, e.g., a call session control function (CSCF) node (not shown in FIG. 1). According to an exemplary embodiment, a proxy user agent 110 maintains a stateful proxy user agent client (software entity) and can perform the conversion of the SIP signaling to a format useable by the end user device 116. According to exemplary embodiments, the proxy user agent 110 can receive or fetch grammars from the application server 106 or have grammars stored in local memory, or some combination thereof as desired. The grammar which is fetched or received corresponds to the capabilities of the particular end user device 116 for which termination of a particular SIP service is desired. As described in more detail below, this flexible approach enables proxy user agents according to these exemplary embodiments to terminate SIP applications toward a variety of end user devices, including new devices as they enter the market, without requiring substantial amounts of system re-engineering.

IMS core 112 generally represents the required authorization, control and communication functions of an IMS core network used to support communications between the proxy user agent 110 and the Media Gateway Controller/Media Gateway MGC/MGW 114 in support of the application to be used between the end user device 116 and the application server 106. MGC/MGW 114 sits between the circuit switched and packet switched networks and performs some signaling/media conversion as well as establishing connection with the end user device 116. Communication system 100 shows the basic nodes used in support of a grammar which can be used to deliver a service to an end user device 116 which is not able to have a user agent for terminating an application client, e.g., end user device 116 either does not have a client, is not registered to the IMS network, or has a client which is failing and therefore needs to be redirected to a proxy user agent 110. Note that in some of these cases the end user device 116 could have SIP capabilities but, for whatever reasons, these capabilities are currently not performing at an adequate level for the application to terminate properly on the end user device 116. It will be appreciated that the exemplary system illustrated in FIG. 1 is purely illustrative and that more or fewer nodes and networks can be a part of the communication system 100 as needed or desired.

Based upon the exemplary communication system 100 shown in FIG. 1, and according to exemplary embodiments, a purely illustrative example for selecting and using a grammar by a proxy user agent will now be described in the case of a banking transaction that needs to be authenticated. Initially, suppose that an end user device 116 is attempting to perform a banking transaction and the session setup mechanism detects that the end user device 116 needs to be directed to the proxy user agent 110 because, e.g., the end user device 116 is not SIP capable. The proxy user agent client that terminates the session can use methods such as a circuit switched call or a media gateway call toward the end user device 116 for session termination. The proxy user agent 110 can then, based on the syntax of the received application message and the chosen grammar, send information to the end user device 116. In return, the end user device 116 can transmit its response using, e.g., voice commands and tone inputs or some combination thereof, which are then converted by the proxy user agent 110 into response messages and sent to the originating client, e.g., via SIP signals to the responsible bank.

The provision of one or more codec(s) for application termination can be part of the grammar sent by the application server 106, e.g., in this exemplary case the accessing of an analog channel using standard functionality and Dual Tone Multi-Frequency (DTMF) tones, as well as the decoding of the incoming message syntax and translation of that syntax into voice or tone analog signals based on the grammar used by the proxy user agent 110. The proxy user agent client residing on the proxy user agent 110 behaves as though it is a client residing on a mobile phone or other end user device 116 so that the handling from the application's point of view is seamless regardless of whether the application is terminated on the proxy user agent 110 or the end user device 116. The proxy user agent client can be designed to expect a standardized syntax in its received messages, e.g., the syntax that is typically carried in a SIP messaging payload that is decoded and translated into actions towards the target device, e.g., the end user device 116.

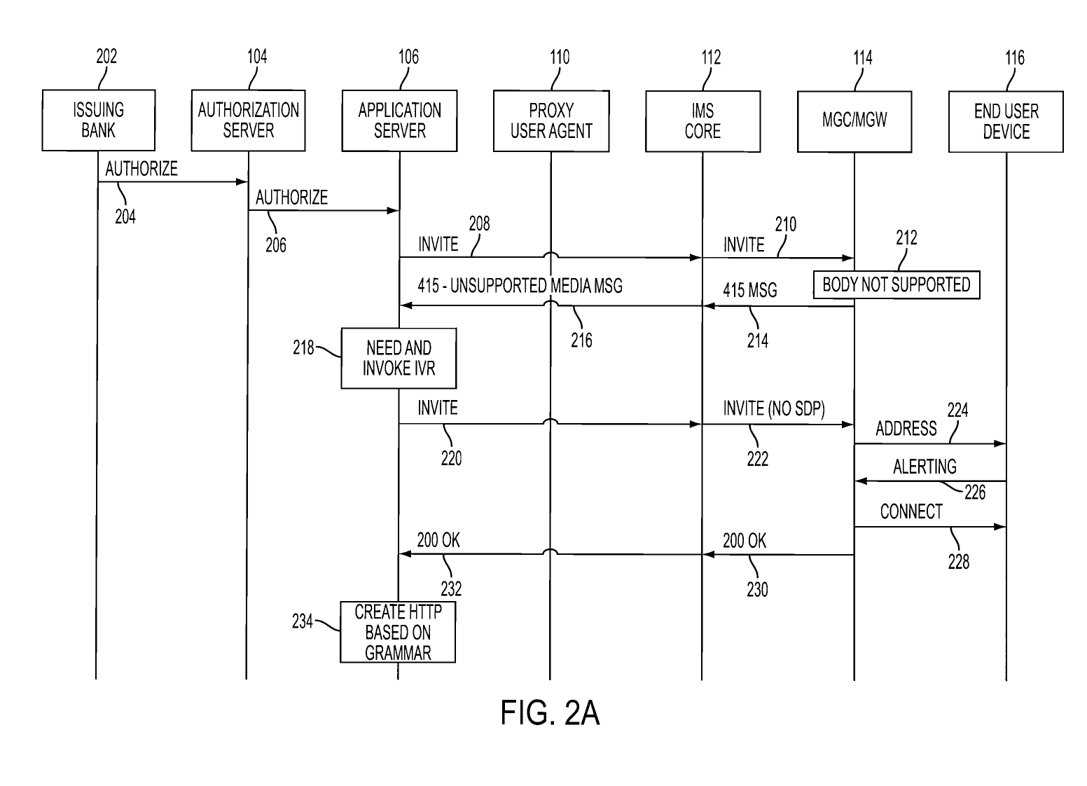

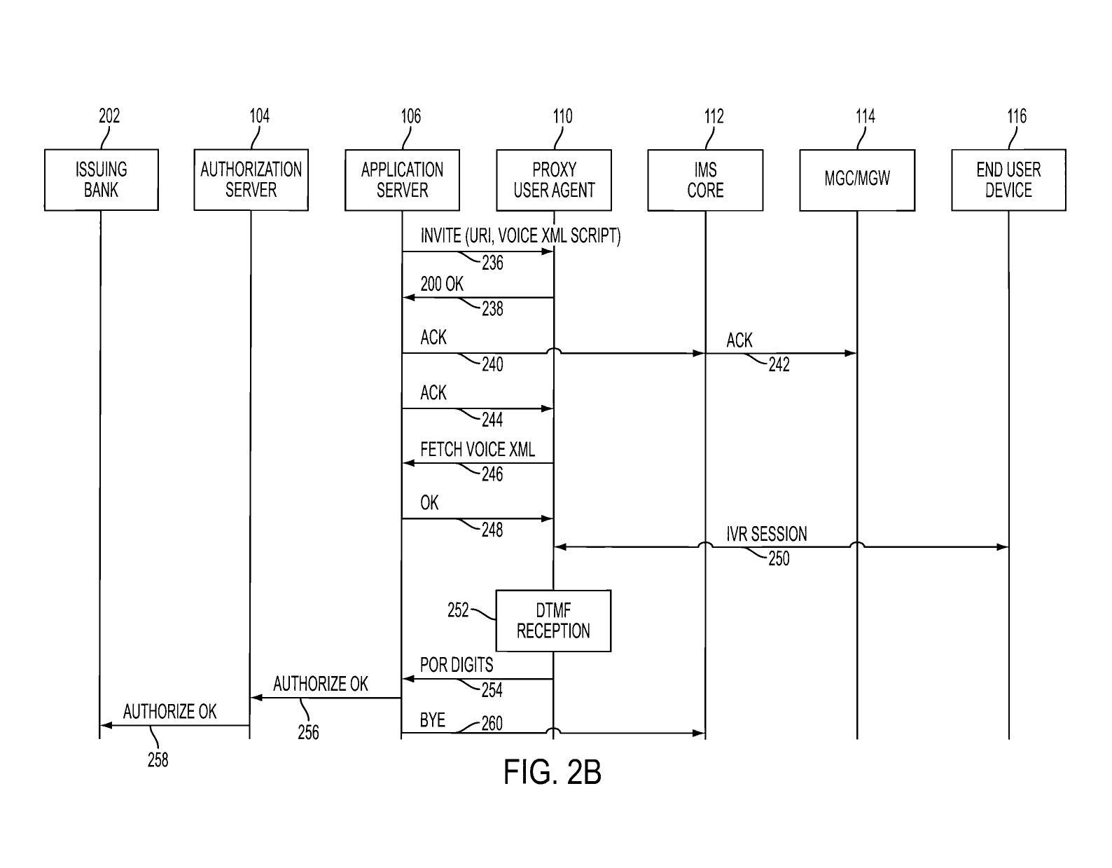

According to exemplary embodiments, a signaling diagram for performing an authorization between a bank and an end user device 116 when the application server responsible for handling this banking transaction either does not know the grammar needed by the proxy user agent 110 to handle that end user device 116 or believes, incorrectly, that the end user device 116 is currently SIP capable, will now be described with respect to FIGS. 2(a) and 2(b). Initially, a transaction has occurred, e.g., a purchase through a point-of-sale (POS) terminal, and a bank 202 desires to complete the transaction with the end user by verifying authorization. In this example, suppose that the user has an end user device 116 which is not SIP capable. The issuing bank 202 transmits an Authorize message 204 to an associated authorization server 104. This Authorize message 204 begins the process of verifying with an end user that he or she actually requested the transaction. Authorization server 104 then transmits an Authorize message 206 to an application server 106. Application server 106 transmits a SIP Invite message 208 to the IMS Core 112 which in turns transmits a SIP Invite message 210 to the MGC/MGW 114 associated with the end user device 116. In this case, the MGC/MGW 114 knows, from earlier communications and stored information, that the end user device 116 does not have a SIP-capable user agent, i.e., end user device 116 cannot terminate SIP messages, and as such determines that the body of the SIP Invite message 210 is not supported by the end user device 116 as shown in block 212. The MGC/MGW 114 then transmits a 415 Unsupported Media message 214 to the IMS Core 112. The IMS Core 112 then transmits the 415 Unsupported Media message 216 back to the application server 106.

The 415 Unsupported Media message 216 informs the application server 106 that the grammar initially used, e.g., SIP, is not supported by the end user device 116 resulting in a failed transaction. The application server 106 then knows that a different grammar needs to be supplied to communicate with the end user device 116 as shown in block 218. In this case, the application server 106 changes a Hyper Text Transfer Protocol (HTTP) header in the Invite message 220 to show that a new grammar, e.g., Interactive Voice Response (IVR), is to be used, and transmits the Invite message 220 to the IMS Core 112 which then transmits an Invite message 222 with no Session Description Protocol (SDP) field to the MGC/MGW 114. This process, i.e., the communication loop between the application server 106 and the MGC/MGW 114 with Invite messages and corresponding unsupported media messages, can be repeated until a grammar that the end user device 116 can communicate with is received by the MGC/MGW 114.

According to exemplary embodiments, once the application server 106 signals the MGC/MGW 114 with an indication of a grammar set which is usable by this particular end user device 116, the MGC/MGW 114 then sets up a connection with the end user device 116 as shown by the message sequence address 224, alerting 226 and connecting 228 between the MGC/MGW 114 and the end user device 116. A 200 OK message 230 is transmitted from the MGC/MGW 114 to the IMS Core 112 which can include, for example, information regarding the grammar that the end user device 116 desires to use and contact/location information for the end user device 116. The grammar chosen by the end user device 116 could be determined by either selecting from a list provided to the MGC/MGW 114 in Invite message 222 or by accepting the proffered grammar in Invite message 222 if it is the only grammar offered and usable by the end user device 116. For example, the Invite messages 220 and 222 could include a list of grammars useable by the application server 106 such as HTTP, IVR, ASCII, combinations thereof and the like, or alternatively the Invite messages 220 and 222 could just include a single grammar and the process would be repeated until that single grammar listed is useable by both the end user device 116 and the application server 106. This information. i.e., the selection of IVR over HTTP as the grammar in this example, is then transmitted from the IMS Core 112 in a 200 OK message 232 to the application server 106.

The application server 106, based upon the selection by the end user device 116 of IVR over HTTP as the grammar, creates the necessary IVR and HTTP information for the application to be processed. Additionally, the application server 106 stores this information linking this specific end user device 116 to its grammar choice for future use (this could greatly reduce the amount of signaling associated with this specific end user device 116 for processing future applications). Continuing on to FIG. 2(b), the application server 106 transmits an Invite message 236 which includes a Uniform Resource Identifier (URI) and voice eXtensible Markup Language (XML) script. This information allows the proxy user agent 110 to access the grammar to be used, i.e., HTTP over a voice XML script, with the end user device 116 as well as how to contact/locate the end user device 116, e.g., the URI associated with the end user device 116. The proxy user agent 110 responds to the Invite message 236 with a 200 OK message 238 back to the application server 106. Around this time, the application server 106 also acknowledges receipt of the earlier 200 OK message 232 from the IMS Core 112 and sends an ACK message 240 to the IMS Core 112, which in turn prompts the IMS Core 112 to transmit an ACK message 242 to the MGC/MGW 114. Also, the application server 106 transmits an ACK message 244 with the desired SDP to the proxy user agent 110 which allows the media path between the proxy user agent 110 and the MGC/MGW 114 to be established.

According to exemplary embodiments, the application server 106 and the proxy user agent 110 generally divide responsibilities associated with these processes such that the application server 106 is responsible for providing the service and the proxy user agent 110 is responsible for providing conversion of the service and associated information (in both directions), as well as handshaking/interfacing with the end user device 116 to facilitate delivery of the service. However, some overlap in performing these various functions between these two nodes can occur as desired. For example, the proxy user agent 110 can perform a fetch of the HTTP over voice XML script from the application server 106, as shown in message 246, as needed to convert instructions regarding the service from the application server 106 in its original grammar, e.g., SIP, to the grammar selected by the end user device 116. The application server 106 responds to this fetch request with a 200 OK message 248. An IVR session 250 is then set up between the proxy user agent 110 and the end user device 116 during which the service information, e.g., transaction authorization information, is exchanged.

The proxy user agent 110, during the IVR session 250, additionally receives dual-tone multi-frequency (DTMF) signals, as shown in block 252, which are used to respond to or perform the service request. For example, in this case, the tones can correspond to buttons pushed on a mobile phone which match a personal identification number (PIN) to verify authorization of a transaction. This information is then transmitted from the proxy user agent 110 to the application server 106 in the POS digits message 254. The authorization server 106 then takes this received information and matches it to the requested service and determines whether the received information allows for authorization or not. In this exemplary case, authorization is allowed and this result is transmitted in Authorize OK message 256 from the application server 106 to the authorization server 104 which in turn transmits Authorization OK message 258 to the Issuing Bank 202. Alternatively, if the information in signal 254 indicated an invalid transaction, a failure message could be returned. To terminate this process, the application server 106 ends the session with the IMS Core 112 as shown in Bye message 260.

As described above, according to exemplary embodiments, an application server 106 can store the grammar associated with a particular end user device 116. Additionally, or alternatively, this information can be stored by the proxy user agent 110. According to another exemplary embodiment, the end user device 116 can change the grammar preference, e.g., from SIP to HTTP, HTTP to an ASCII/IVR combination, etc., used by the proxy user agent 110 and stored by the application server 106 to reduce overall signal traffic.

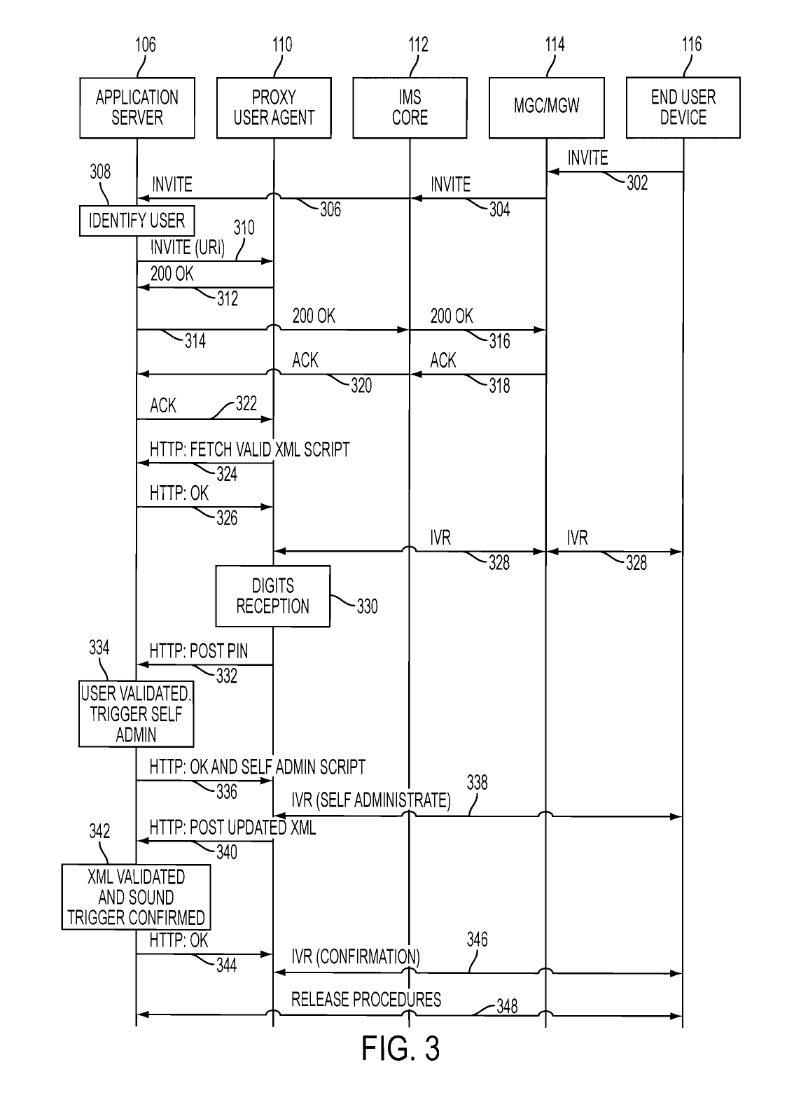

According to exemplary embodiments, for the user to change grammars, e.g., through self administration, certain information and settings typically need to be available. For example, in the case of a secure card service, e.g., banking services, the end user would need to have and know a secure identification number which is also known by the secure card service, e.g. a PIN associated with the banking service. The secure card service would need to be configured on an application server 106 for this particular end user. Additionally, a suitable network connection would need to be available between the end user device 116 and the application server 106 as well as allowing IVR to be a viable fallback for communications. Once these provisions or similar provisions are in place, self administration of grammars according to exemplary embodiments can occur as will now be described with respect to the signaling diagram shown in FIG. 3.

Initially suppose that a user determines that he or she desires to change the currently used grammar, e.g., SIP to a voice XML script over IVR, since the user is going to a location which does not support SIP signaling. In response to some user input, the end user device 116 transmits an Invite message 302 to the MGC/MGW 114 which includes information for identifying/authenticating the user to the application server 106 and a new information element for telling the application server 106 to change its setting from grammar A, e.g., SIP, to grammar B, e.g., voice XML script over IVR. This information is then transmitted in Invite message 304 to the IMS Core 112, which in turn transmits an Invite message 306 to the application server 106. The application server 106 then uses the identification information in the Invite message 306 to verify that the end user making this grammar change request is indeed a user authorized to make this change as shown in the Identify User block 308. The invite coming from Invite message 306 to the Identify User Block 308 uses standard IMS identification in the SIP header. In the SIP header the SIP URI is available and this is cross matched in the Application server 106 using its local data base or validating against the Home Subscriber Server (HSS) associated with the IMS network 108.

After verifying user credentials, the application server 106 transmits an Invite message 310 which includes the URI of the validation XML script to the proxy user agent 110 for the change requested by the end user device 110. The proxy user agent 110 responds with a 200 Ok message 312 to the application server 106. Around this time, the application server 106 responds to the earlier received invite message 306 and responds with a 200 OK message 314 back to the IMS Core 112 which in turn transmits a 200 OK message 316 to the MGC/MGW 114. The MGC/MGW 114 then transmits an ACK message 318 to the IMS Core 112 which in turn transmits an ACK message 320 to the application server 106 thus completing the user identification confirmation process for the desired grammar change.

Application server 106 additionally transmits an ACK message 322 which includes the desired SDP to the proxy user agent 110 that allows the media path between the proxy user agent 110 and the MGC/MGW 114 to be established. The proxy user agent 110 then, using HTTP in this exemplary case, sends a fetch valid XML script request message 324 to the application server 106 and fetches the new grammar. The application server 106 responds with an HTTP OK message 326. An IVR session is then set up between the proxy user agent 110 and the end user device 116 through the MGC/MGW 114 as shown by the IVR session communication message(s) 328. Through this IVR session 328, the end user device 116 is prompted to verify and validate the requested grammar change. To do this, the end user device 116 transmits an authorization code, e.g., a personal identification number (PIN), to the proxy user agent 110 as shown in the digits reception block 330. The proxy user agent 110 then transmits an HTTP message 332 which includes the PIN (or other predetermined authorization information) to the application server 106. This allows the application server 106 to validate this request and to trigger self administration to test the new grammar as shown in block 334.

To initiate the self administration, the application server 106 transmits an HTTP OK message 336 which includes instructions to perform self administration of the new grammar script. Self administration IVR communications 338 occur to verify that the new grammar works for all nodes involved. Upon a successful test, the proxy user agent 110 transmits an HTTP message 340 which includes instructions to post the updated XML script. The application server 106 then acknowledges that the new grammar has been successfully tested and that the sound trigger was confirmed in block 342. Additionally, this information linking the new grammar to the end user device 116 can be stored by both (or either) the application server 106 and the proxy user agent 110. The application server 106 then sends an HTTP OK message 344 back to the proxy user agent 110 which in turn, notifies the end user device 116 of confirmation as shown by the IVR confirmation communications 346. This updating procedure is then completed by the various nodes and devices following standard release procedures 348.

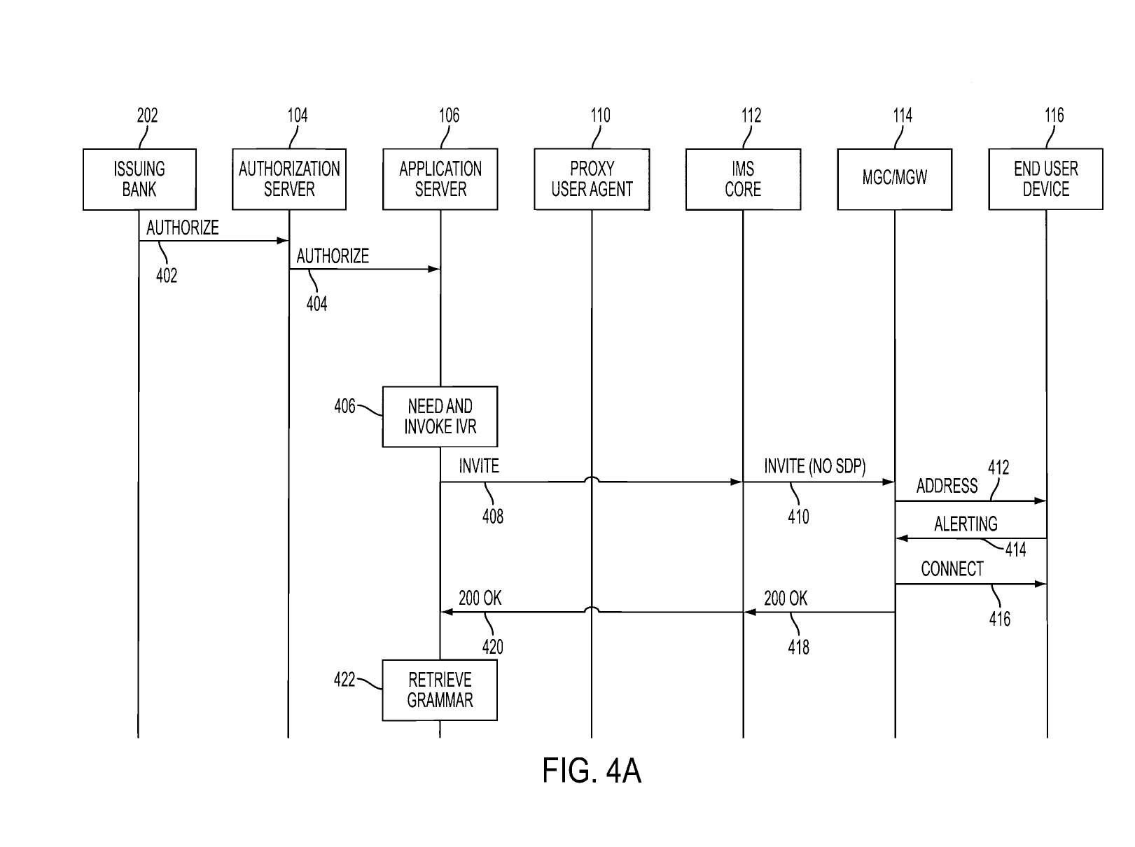

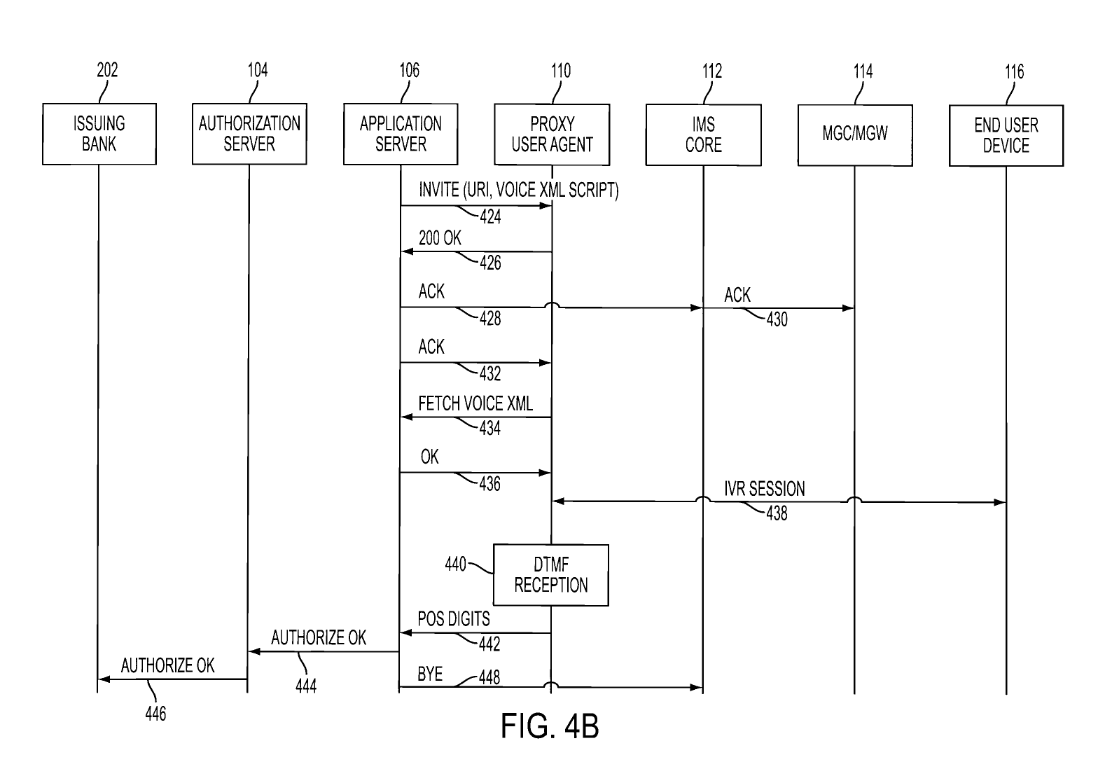

According to exemplary embodiments described above, the application server 106 can store a preferred grammar for an end user device 116. The signaling diagram for the exemplary use case where an authorization transaction is to occur with an end user device 116 for which the appropriate grammar is known, e.g., by the application server 106, will now be described with respect to FIGS. 4(a) and 4(b). Initially suppose that a transaction has occurred and a bank 202 desires to complete the transaction with the end user through a device by verifying authorization. To support this process, the issuing bank 202 transmits an Authorize message 402 to an associated authorization server 104. This Authorize message 402 begins the process of verifying with an end user that he or she actually requested the transaction. Authorization server 104 then transmits an Authorize message 404 to an application server 106. From previously stored information associated with the user identified in the Authorize message 404, the application server 106 knows that it needs to invoke IVR as shown in block 406, establish a connection with the end user device 116 through the system and ensure that the previously selected grammar is available for the proxy user agent 110.

Application server 106 transmits a SIP Invite message 408 to the IMS Core 112 which in turns transmits a SIP Invite message 410 with no SDP to the MGC/MGW 114 associated with the end user device 116. According to exemplary embodiments, the MGC/MGW 114 then sets up a connection with the end user device 116 as shown by the message sequence address 412, alerting 414 and connecting 416 between the MGC/MGW 114 and the end user device 116. A 200 OK message 418 is transmitted from the MGC/MGW 114 to the IMS Core 112 which includes information regarding the connection. The IMS Core then transmits a 200 OK message back to the application server 106. The application server 106, based upon the previously stored information, retrieves the desired grammar.

Continuing in FIG. 4(b), the application server 106 transmits an Invite message 424 which includes a Uniform Resource Identifier (URI) and voice eXtensible Markup Language (XML) script. This information allows the proxy user agent 110 to access the grammar to be used, i.e., HTTP over a voice XML script, with the end user device 116 as well as how to contact/locate the end user device 116, e.g., the URI associated with the end user device 116. The proxy agent user 110 responds to the Invite message 424 with a 200 OK message 426 transmitted back to the application server 106. Around this time, the application server 106 also acknowledges receipt of the earlier 200 OK message 420 from the IMS Core 112 and sends an ACK message 428 to the IMS Core 112 which in turn prompts the IMS Core 112 to transmit an ACK message 430 to the MGC/MGW 114. Also, the application server 106 transmits an ACK message 432 with the desired SDP to the proxy user agent 110 which allows the media path between the proxy user agent 110 and the MGC/MGW 114 to be established.

According to exemplary embodiments, the proxy user agent 110 may have previously stored the grammar associated with end user device 116. In this case the proxy user agent 110 would then initiate the IVR session 438. If however the proxy user agent needed the grammar, the proxy user agent 110 performs a fetch of the HTTP over voice XML script, as shown in message 434, as needed to convert instructions regarding the service from the application server 106 in its original grammar, e.g., SIP, to the grammar selected by the end user device 116. The application server 106 responds to this fetch request with a 200 OK message 436. An IVR session 438 can then be set up between the proxy user agent 110 and the end user device 116 during which session the service information, e.g., transaction authorization information, is exchanged.

The proxy user agent 110, during the IVR session 438, additionally receives dual-tone multi-frequency (DTMF) signals, as shown in block 440, which are used to respond to or perform the service request. For example, in this case, the tones can correspond to buttons pushed on a mobile phone which match a personal identification number (PIN) to verify authorization of a transaction. This information is then transmitted from the proxy user agent 110 to the application server 106 in the PUS digits message 442. The authorization server 106 then takes this received information, matches it to the requested service and determines whether the received information allows for authorization or not. In the illustrated case, authorization is allowed and this result is transmitted in Authorize OK message 444 from the application server 106 to the authorization server 104 which in turn transmits Authorization OK message 446 to the Issuing Bank 202. Alternatively, if the user signals that the transaction is invalid, then a signal to that effect can be transmitted back to the authorization server 104. To terminate this process, the application server ends the session with the 1MS Core 112 as shown in Bye message 448.

Using the exemplary systems and methods described above, purely illustrative code with comments is described below showing a grammar example. Initially suppose that the need for a grammar has been determined, e.g., blocks 406 and 422 in FIG. 4. The Application server 106 transmits an Invite message 424, e.g., an invite to the proxy user agent 110 with, for example, the following payload:

```
<scs phase=”invite”>
  <phone>1234567890</phone>
  <webUri> webregister@home.com </webUri>
<Connect Methods>n </Connect Methods> (The connect methods
indicates the number of options in which
the UA proxy server is to try and connect.)
<Connect Method Type= IVR>
<Language> English UK </Language>
<Voice Preference>
    <Gender> Female </Gender>
    <Age> age </Age>
    <Voice Type> Soft, hard, inviting, cooing ... </Voice Type>
</Voice Preference>
```

After the contact information is received by the proxy user agent 110, the grammar can be retrieved. The grammar can, for example, be broken up into four portions: (1) Presentation to the Terminal; (2) Prompt Inputs from the user; (3) Response to prompts from the user (which is nested in portion (2) in the example below); and (4) Help interface to the area, an example of which grammar is provided below. It will be appreciated by those skilled in the art that this example is purely illustrative and that grammars according to these exemplary embodiments can be expressed in different manners and formats.

```
      <Terminal Presentation>
        <PLAY Template> Hello “Holder Name”. You have received a transaction
        authentication for your “Card Type” for “amount” “currency” at “Bank”
        “location”.</Play Template>
        <holdername>FirstName LastName</holdername>
        <cardtype>visa/mastercard/amex</cardtype>
        <cardnum>xxxx<cardnum> (only last 4 digits)
        <amount>500</amount> (only digits)
        <currency>SEK</currency>
        <bank>SEB</bank> (the card issuing bank)
        <location>
                    <street> </street>
                    <city> </city>
                    <country> </country>
        </location>
      </Terminal Presentation>
    <Prompt Inputs from user>
      <PLAY Template> To accept this transaction Please enter your pin code
      now.</Play Template>
      <Wait input>
              <time> time </time>
              <input type> DTMF tone </input type>
              <Validate input> Validation server </validate input>
              <On Validate success>
              <PLAY Template> Transaction successful. Goodbye</Play Template>
              <On Validate error>
              <PLAY Template> Invalid Pin. You have two more chances or your
      card will be locked out. Hash to cancel transaction </Play Template>
              </On Validate error>
              ... (I/O cycles can be repeated here)
              </Wait Input>
      </Prompt Inputs from user>
      </Terminal Presentation>
      </Connect Method Type>
    <Connect Method Type = Servlet transfer>
          <Client servlet type>
          <Client model> W910 </Client model>
            <servlet> Bin file </servlet>
            </Client Servlet type>
          <Server servlet> Bin file 1 </Server Servlet>
          (in this example, the target terminal client and server end app
is transferred in a binary)
    </Connect Method Type>
  <Help Section>
        <Help Trigger> ## </Help Trigger>
      <PLAY Template> Play Message </Play Template>
      <Help servlet> Servlet </Help servlet>
  </Help Section>
</scs phase >
```

According to alternative exemplary embodiments, the above described code could have been a Web URI termination or a java midlet or servlet in the SIP message payload.

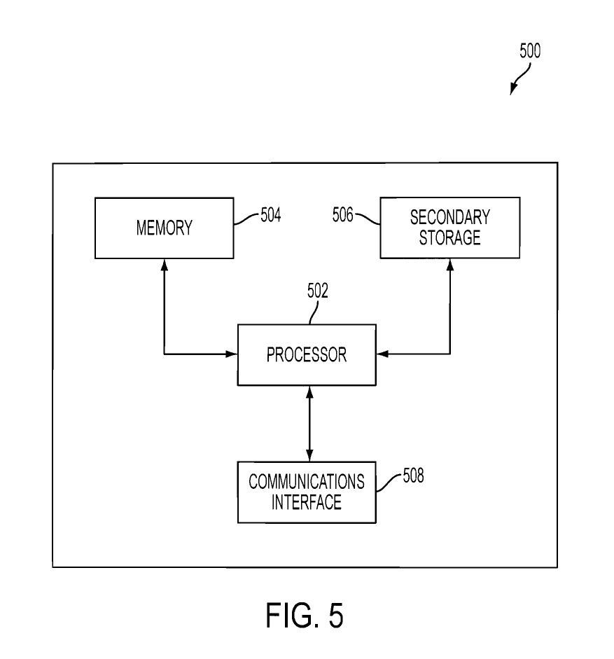

The exemplary embodiments described above provide for a proxy user agent 110 to perform the conversion of SIP based transactions into a format which useable by the end user device 116. An exemplary communications node 500 which can be used, for example, to act as a proxy user agent 110, will now be described with respect to FIG. 5. The communications node 500 can contain a processor 502 (or multiple processor cores), memory 504, one or more secondary storage devices 506 and an interface unit 508 to facilitate communications between the communications node 500 and the rest of the communication system 100. Grammars, conversion instructions and associated end user device 116 information can be stored in either the memory 504 or a secondary storage device 506 (if such grammars are stored locally relative to the proxy user agent 110). Using stored information, processor 502 can covert from a first grammar to a second grammar as desired. Additionally, communications node 500 can facilitate IVR sessions with an end user device 116. Thus communications node 500 can perform all of the functions of a proxy user agent 110. Communications node 500 can also perform the functions of an application server or an end user device when configured as such.

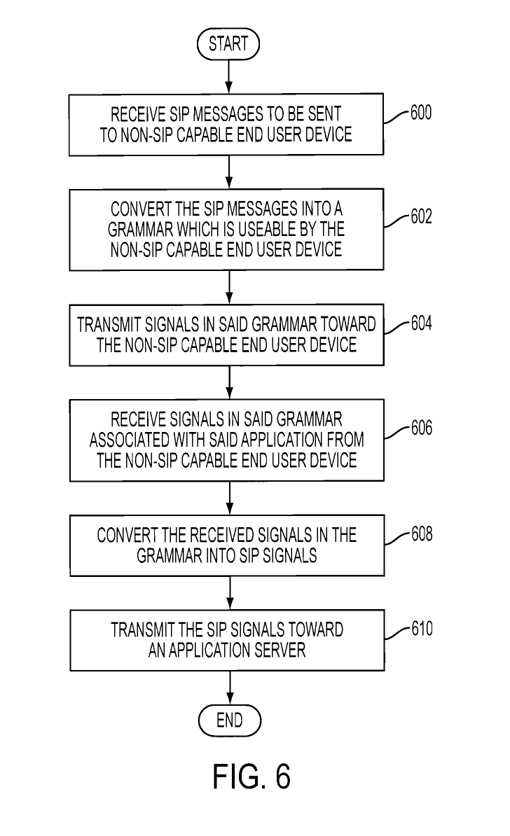

Utilizing the above-described exemplary systems according to exemplary embodiments, a method for converting Session Initiation Protocol (SIP)-based messages associated with an application into a grammar usable by a non-SIP capable end user device is shown in the flowchart of FIG. 6. Therein, at step 600, SIP-based messages are received at a proxy user agent node, which messages are to be sent to the non-SIP capable end user device. These SIP messages are converted, by the proxy user agent, into signals based on the grammar which is usable by the non-SIP capable end user device at step 602. These signals are transmitted, at step 604, toward the non-SIP capable end user device. In response, signals based on the grammar are received, at step 606, by the proxy user agent from the non-SIP capable end user device, which signal are then converted into SIP signals (step 608). The resultant signals are transmitted toward an application server at step 610.

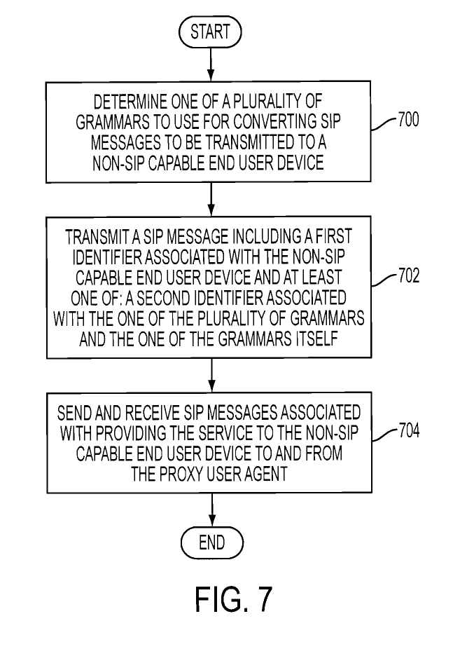

According to another exemplary embodiment, a method for providing a service to a non-Session Initiation Protocol (SIP) capable end user device is shown in the flowchart of FIG. 7. Therein, one of a plurality of grammars to use for converting SIP messages associated with the service to be transmitted to the non-SIP capable end user device is determined by an application server at step 700. Then, a SIP message is transmitted by the application server toward a proxy user agent, which SIP message includes a first identifier associated with the non-SIP capable end user device and at least one of a second identifier associated with the one of the plurality of grammars and the one of the plurality of grammars itself as indicated by step 702. Subsequently, the application server can send and receive SIP messages associated with providing the service to the non-SIP capable end user device to and from the proxy user agent, respectively, at step 704.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for converting Session Initiation Protocol (SIP)-based messages associated with an application based on a grammar which is usable by a non-SIP capable end user device comprising:
receiving, at a proxy user agent (110), said SIP-based messages which are to be sent to said non-SIP capable end user device (116);
converting, by said proxy user agent (110), said SIP-based messages associated with said application into signals based on said grammar which is usable by said non-SIP capable end user device (116);
transmitting, by said proxy user agent (110), said signals toward said non-SIP capable end user device;
receiving, by said proxy user agent (110), signals based on said grammar and associated with said application from said non-SIP capable end user device (116);
converting, by said proxy user agent (110), said received signals into SIP signals; and
transmitting, by said proxy user agent (110), said SIP signals towards an application server (106) which supports said application.

2. The method of claim 1, further comprising:
fetching, by said proxy user agent, said grammar which is usable by said non-SIP capable end user device.

3. The method of claim 1, wherein said grammar includes part of at least one of Hypertext Transfer Protocol (HTTP), Interactive Voice Response (IVR) and American Standard Code for Information Interchange (ASCII).

4. The method of claim 1, wherein said proxy user agent is implemented within a node in a communications network.

5. The method of claim 4, further comprising:
storing, in said node, said grammar which is usable by said non-SIP capable end user device and associating said grammar with said non-SIP capable end user device.

6. The method of claim 1, wherein said application is a secure card service application associated with a bank.

7. The method of claim 1, further comprising:
identifying one of a plurality of grammars to use as said grammar for converting said SIP messages to be transmitted to said non-SIP capable end user device.

8. A method for providing a service to a non-Session Initiation Protocol (SIP) capable end user device (116) comprising:
determining, by an application server (106), one of a plurality of grammars to use for converting SIP messages associated with said service to be transmitted to said non-SIP capable end user device (116);
transmitting, by said application server (106) and toward a proxy user agent (110), a SIP message including a first identifier associated with said non-SIP capable end user device (116) and at least one of : a second identifier associated with said one of said plurality of grammars and said one of said plurality of grammars itself; and
sending and receiving, by said application server (106), subsequent SIP messages associated with providing said service to said non-SIP capable end user device (116) to and from said proxy user agent (110), respectively.

9. The method of claim 8, wherein said step of determining further comprises:
iteratively transmitting messages, by said application server, each associated with a different one of said plurality of grammars, toward said non-SIP capable end user device until said one of said plurality of grammars is identified which said non-SIP capable end user device can accommodate.

10. The method of claim 8, wherein said step of determining further comprises:
transmitting, by said application server, a list of said plurality of grammars toward said non-SIP capable end user device; and
receiving, at said application server, an indication of said one of said plurality of grammars.

11. The method of claim 8, further comprising:
storing, in said application server, an association between said one of said plurality of grammars and said non-SIP capable end user device.

12. A proxy user agent (110) for converting Session Initiation Protocol (SIP)-based messages associated with an application based on a grammar which is usable by a non-SIP capable end user device comprising:
a communications interface (508) for receiving and transmitting signals;
wherein said received signals include said SIP-based messages which are to be sent to said non-SIP capable end user device,
wherein said transmitted signals include signals toward said non-SIP capable end user device based upon said grammar and said received SIP-based messages, and SIP signals towards an application server which supports said application;
a memory (504) for storing said grammar; and
a processor (502) for converting said SIP-based messages associated with said application into said transmitted signals based on said grammar which are usable by said non-SIP capable end user device and for converting signals based on said grammar and associated with said application from said non-SIP capable end user device into SIP signals,

13. The proxy user agent of claim 12, wherein said proxy user agent fetches said grammar which is usable by said non-SIP capable end user device.

14. The proxy user agent of claim 12, wherein said grammar includes part of at least one of Hypertext Transfer Protocol (HTTP), Interactive Voice Response (IVR) and American Standard Code for Information Interchange (ASCII).

15. The proxy user agent of claim 12, wherein said proxy user agent is implemented within a node in a communications network.

16. The proxy user agent of claim 15, wherein said grammar is associated with said non-SIP capable end user device, said association being stored in memory.

17. The proxy user agent of claim 12, wherein said application is a secure card service application associated with a bank.

18. The proxy user agent of claim 12, wherein said proxy user agent node further identifies one of a plurality of grammars to use as said grammar for converting said SIP messages to be transmitted to said non-SIP capable end user device.

19. An application server (106) for providing a service to a non-Session Initiation Protocol (SIP) capable end user device (116) comprising:
a memory (504) for storing a plurality of grammars;
a processor (502) for determining which one of said plurality of grammars to use for converting SIP messages associated with said service to be transmitted to said non-SIP capable end user device (116); and
a communications interface (508) for transmitting, toward a proxy user agent (110), a SIP message including a first identifier associated with said non-SIP capable end user device (116) and at least one of: a second identifier associated with said one of said plurality of grammars and said one of said plurality of grammars itself,
wherein said communications interface (508) further sends and receives, subsequent SIP messages associated with providing said service to said non-SIP capable end user device (116) to and from said proxy user agent (110), respectively.

20. The application server of claim 19, wherein the communications interface iteratively transmits messages, each associated with a different one of said plurality of grammars, toward said non-SIP capable end user device until said one of said plurality of grammars is identified which said non-SIP capable end user device can accommodate.

21. The application server of claim 19, wherein the communications interface transmits a list of said plurality of grammars toward said non-SIP capable end user device and receives an indication of said one of said plurality of grammars.

22. The application server of claim 19, wherein said memory stores an association between said one of said plurality of grammars and said non-SIP capable end user device.
